(19) United States
(12) Patent Application Publication
(10) Pub. No.: US 2024/0214423 A1
(43) Pub. Date: Jun. 27, 2024

(54) SYSTEM AND METHOD FOR SECURING CLOUD BASED SERVICES

(71) Applicant: KIVERA CORPORATION, Toronto (CA)

(72) Inventors: Neil Brown, Chippendale, New South Wales (AU); Vernon Jefferson, Chippendale, New South Wales (AU)

(21) Appl. No.: 17/909,731

(22) PCT Filed: Mar. 3, 2021
(86) PCT No.: PCT/CA2021/050277

§ 371 Date: Sep. 6, 2022

Related U.S. Application Data
(60) Provisional application No. 62/984,725, filed on Mar. 3, 2020.

(51) Int. Cl. H04L 9/40; G06F 9/54

(52) U.S. Cl. CPC H04L 63/20; G06F 9/547

(57) ABSTRACT

A cloud security proxy is described that is able to process requests for cloud services in order to validate the requests against specified rules and/or policies. The cloud security proxy provides greater security for cloud-based applications while providing developers with greater flexibility in the choice of development tools while maintaining a strong security posture for the organization.

### CROSS REFERENCE TO RELATED APPLICATIONS

This application is a U.S. national phase of PCT International Patent Application No. PCT/CA2021/050277, filed Mar. 3, 2021 and titled “SYSTEM AND METHOD FOR SECURING CLOUD BASED SERVICES”, which claims priority to and claims the benefit of U.S. Provisional Application No. 62/984,725 filed Mar. 3, 2020, the entireties of which are incorporated by reference for all purposes.

### TECHNICAL FIELD

The current disclosure relates to cloud-based applications or services and in particular the security of cloud-based applications or services.

### BACKGROUND

Organizations, particularly regulated entities, may enforce a level of abstraction between the developer and the cloud provider. This abstraction layer (often referred to as a continuous integration and delivery “CI/CD” pipeline) allows for an organization to apply a level of consistency when consuming the cloud environment. Consumption may include building, deploying, configuring and utilizing cloud resources such as compute, storage and modern infrastructure concepts like functions. Having a single, consistent way of consuming cloud allows for preventative governance controls to be applied uniformly across the organization's cloud deployments greatly reducing risk.

As cloud maturity in the organization increases, developers may desire a more cloud native consumption experience which leverages common industry tooling. To support developers, some organizations have broadened the consumption landscape to allow developers to choose their own tooling. This expansion in tooling increases developer flexibility but negatively impacts security posture as the consistent and standardised control plane has now dissolved and each developer may be responsible for implementing their own controls.

To help mitigate this risk, organizations adopting this open consumption method tend to leverage a 3rd party Cloud Security Posture Manager (CSPM) or a detective tool which has access to the entire cloud environment and continually scans cloud resources looking for a misconfiguration or policy breach. These detective tools, however, do not provide the same control effectiveness that custom CI/CD pipeline implementation provide which can be further compounded by different development teams in the organization seeking varied tooling.

Developers have a desire for a less restrictive experience and regulated organizations have a desire to avoid the additional risk of this approach.

Therefore there is a need to improve the security of cloud-based application or service deployments while maintaining development flexibility.

### BRIEF DESCRIPTION OF THE DRAWINGS

Further features and advantages of the present disclosure will become apparent from the following detailed description taken in combination with the appended drawings, in which:

FIG. 1 depicts a cloud-based application or service environment;

FIG. 2 depicts a method for securing cloud based applications;

FIG. 3 depicts components of a cloud security proxy; and

FIG. 4 depicts a method of validating a cloud request.

### DETAILED DESCRIPTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for providing security in cloud-based environments. The method also includes receiving a cloud service API request intended for a cloud-based service. The method also includes processing the received cloud request to a standard format. The method also includes determining one or more rules or policies to apply. The method also includes applying the determined one or more rules or policies to the processed request. The method also includes if all of the rules or policies are passed, transmitting the cloud request to the cloud-based service. The method also includes if one or more of the rules or policies are not passed, blocking the cloud request from being transmitted to the cloud-based service. Other embodiments of this aspect include corresponding computer systems, apparatus, and computer programs recorded on one or more computer storage devices, each configured to perform the actions of the methods.

Implementations may include one or more of the following features. The method where if the one or more of the rules or policies are not passed, the request is allowed when an associated flag is set. The flag is associated with logging the actions associated with the cloud request. The cloud service API request includes a create, read, update or delete action. Applying the determined one or more rules to the processed request includes, for each of the rules: blocking the cloud request if one or more of a provider, host, path, method and action of the processed request does not match a provider, host, path and method of an associated rule. Applying the determined one or more policies to the processed request includes, for each of the policies: applying a policy if the provider, host, path, method and action of the processed request matches the provider, host, path and method of the rules. The policy includes a normalized structured request associated with complex business rules or governance parameters to be associated with the cloud-based service. The cloud request is received from a customer network. The cloud request is received from a client's forwarding proxy associated with the customer network. The method further including providing a notification to identify the blocked cloud request. The one or more rules or policies are stored in one or more associated profiles. Each of the profiles is associated with an identifier, where the received cloud request is associated with a respective identifier used in determining the rules or policies in profiles to be applied to the cloud request. The identifier is associated with a user or application. The received cloud request is received from either a cloud provider or on premise via a client's forwarding proxy. The received cloud provider API request originated at either a cloud provider or on premise and is destined for a second cloud provider. The method further including injection metadata into the cloud request to facilitate tracking of an associated implementation. A cloud security proxy including a processor and memory storing instructions, which when executed by the processor configure the cloud security proxy to perform the method. A non-transitory computer readable memory having stored thereon instructions which when executed by a processor of a device cause the device to perform the method. Implementations of the described techniques may include hardware, a method or process, or computer software on a computer-accessible medium.

The development, deployment and consumption of cloud-based services can be secured by using a security proxy that can validate cloud requests via an application programming interface (API), such as create, read, update of delete actions directed at a cloud service provider, against an organization's security policies to ensure that the request complies with the policies. If the request does not comply with the policy, it can be denied, and a user notified about the denial. If the request does comply with the policies, the request can be sent to the cloud provider and executed. The present system and method may be implemented by a cloud security service or cloud security proxy and provides developers the flexibility to use any of the development tools they desire while ensuring that applications comply with the organization's security policies.

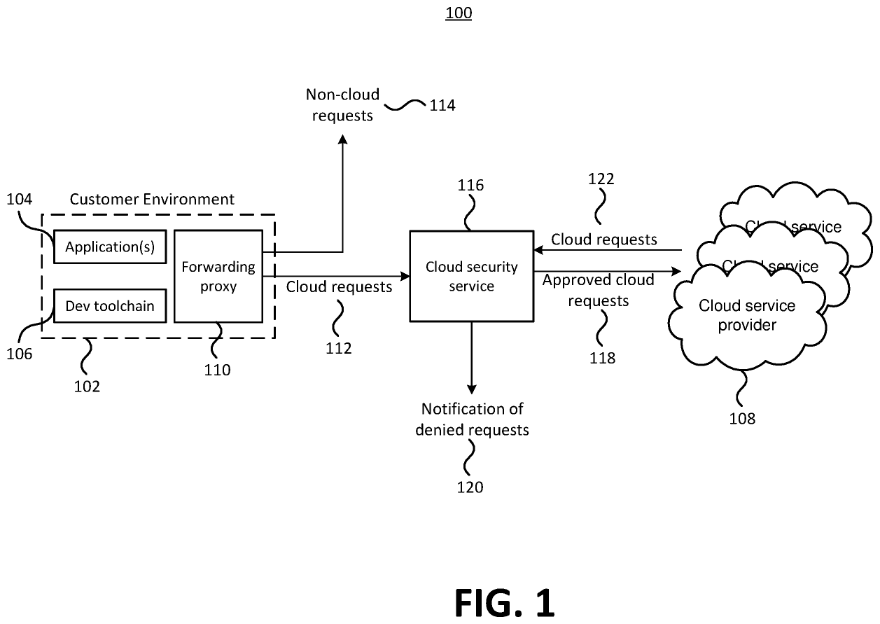

FIG. 1 depicts a cloud-based application or service environment. The environment 100 includes infrastructure of a client 102, which may include infrastructure on premise, as well as in the cloud. The client includes one or more applications 104 and development tools 106. The applications 104 and tool chains 106 may use one or more cloud-based services 108, such as but not limited to Amazon™ Web Services (AWS), Google™ Cloud Platform (GCP), and Microsoft Azure™ (AZURE). The cloud-based services 108 may alternatively be associated with an addressable application programming interface (API) endpoint. The applications 104 and/or tool chains 106 may be used in the development, deployment and consumption of cloud-based services and/or may be cloud based applications. Network traffic from the client may be processed by a forwarding proxy 110. A forward inspection proxy 110 is often used by organizations to control otherwise unrestricted access to the internet. Common use cases include disabling personal e-mail access (e.g. Gmail™) and storage (e.g. Dropbox™) endpoints to restrict data exfiltration vectors. As depicted, the forwarding proxy 110 may be used to forward cloud requests from the client to the cloud security service 116. The non-cloud requests 114 or other network traffic may be processed as normal by the forwarding proxy 110. Although depicted as using a forwarding proxy 110 to forward cloud requests 112 to the cloud security service 116, the cloud requests may be sent to the cloud security proxy in other ways. If no forwarding proxy is used by the client, the client may configure the cloud request traffic to be passed to the cloud security proxy without the proxy chaining. For example, the client may configure the development tools to send the cloud requests directly to the cloud security proxy instead of to the forwarding proxy.

The cloud security service 116 receives and processes cloud requests in order to determine if they should be allowed to proceed based on one or more policies. Approved cloud requests 118 may be sent to the cloud-based service 108 and a notification of denied requests 120 can be provided. In addition to validating cloud requests from the client, cloud requests 122 may be received at the proxy from one or more applications or services running in one or more of the clouds 108. Although cloud requests 122 are depicted as being transmitted from the cloud-based services 108 directly to the cloud security service 116, one or more of the cloud-based services 108 may alternatively be configured to transmit the cloud requests, or possibly all network traffic, to the client's forwarding proxy 110, which would subsequently send the cloud requests to the cloud security service 116. Alternatively partial or all client traffic may be forwarded to the security service 116 without a client proxy 110.

The cloud security proxy comprises an inspection engine with a policy engine. The inspection engine may be used to inspect the content of requests. The policy engine interprets cloud provider API requests from end users or application and applies detailed configuration policy to the user or application's request in real-time. Whereas a traditional CSPM may detect a breach of policy after the breach has occurred, the cloud security proxy policies may be applied in a method which ensures that organizations can achieve preventative compliance to security policies and rules for cloud deployments, without restricting developers tooling choices. The disclosed system and method provides near-real time prevention of misconfigured resources being deployed to the cloud which may impact security. The policies may include regulator aligned sets of rules to simplify the process of ensuring compliance with one or more regulator policies or frameworks.

Cloud security posture management (CSPM)s can assist in identifying misconfigurations of cloud applications or services, however, have the drawback of requiring extended periods of time to report back as the CSPMs must evaluate the log or API data from the cloud applications or services. Cloud access security brokers (CASB)s are unable to provide the same depth in identifying misconfigurations but can perform their core functions of inspecting for exfiltrated data in real-time through the forward inspection proxy method. The current cloud security proxy is able to combine the real-time effectiveness of a CASB while providing even greater depth than a CSPM in identifying misconfigurations and ensuring compliance with policies.

The cloud security proxy is an inline preventative forward proxy that enforces an organization's cloud policies at the network level, while allowing flexibility of a tooling choice for developers. Policy/rulesets may be defined once but can be enforced no matter the tool used including for example CLI, Cloudformation™, Terraform™, Native Client SDKs etc. The cloud security proxy may also be applied to applications or users that leverage multiple cloud providers simultaneously, or applications or users that communicate across cloud providers to other application resources inside the organization.

The cloud security proxy is not intended to replace the cloud providers IAM service, but rather is designed to complement it. Consider the example of creating an instance: the AWS EC2 API action is called RunInstances. IAM allows the organization user or application to grant the ability to make this request to a user but it is not possible to, for example, enforce the Amazon Machine Image (AMI) (AMI) ID that must be used in creating the instance in the policy. Generally, a CI/CD pipeline would be used to enforce the organization's standard operating environment (SOE) image, and only the pipeline is able launch instances to enforce the policy. This does not accommodate developers/sysadmins who wants to use Terraform, AWS command line interface (CLI) or using a python software development kit (SDK) or any tools other than the approved CI/CD pipeline. The use of a CI/CD pipeline results in increased complexity being built into deployment tools to handle both the provisioning of cloud resources and security governance. In this example, the cloud security proxy may be used to validate the appropriate IAM permissions are used and an approved AMI image ID has been selected regardless of developer tool chain being used.

Another example in GCP, when creating a GKE cluster the permission required is containers.clusters.create. The request parameters allow a user to create a public master, which may be a violation of an organization's security policies. If using a detective CSPM tool, this may be identified with an alert. However, this may be an unacceptable risk for the organization as the breach would only have been detected after it had occurred, leading to a weakened security posture. Additionally, any remediation action would lead to a further delay before the breach has been corrected.

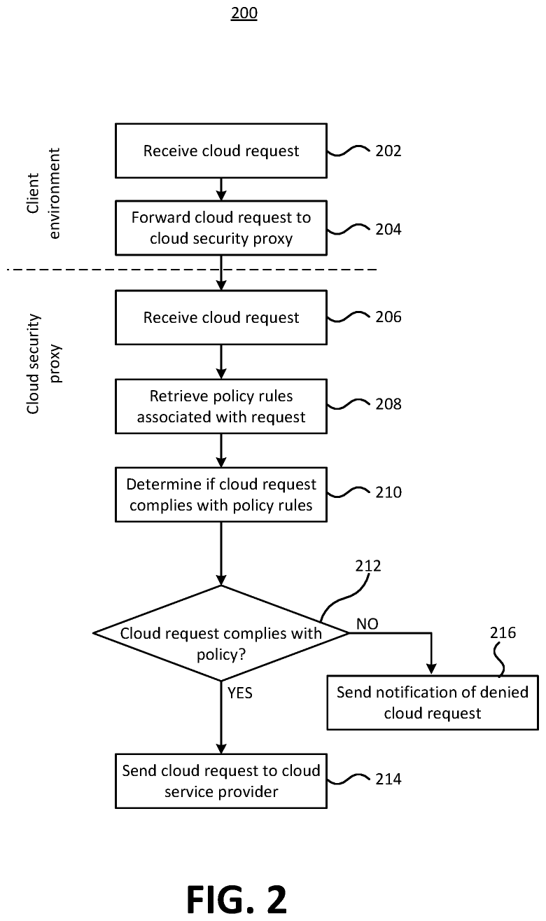

FIG. 2 depicts a method for securing cloud-based applications. The method 200 may comprise receiving a cloud request (202) at the client. The cloud request may be received at a forwarding proxy from a cloud-based application or may be associated with the development and deployment of a cloud-based application. The request is forwarded from the client to a cloud security proxy (204). The cloud security proxy receives the cloud request (206) and determines one or more policy rules associated with the request (208). The rules may be associated with the request through an application that sent the request. For example, an application sending the request may be determined and then used to determine one or more rules to be applied for the application. The rules may be applied to the request to determine if the cloud request complies with the policy rules (210). If the cloud request complies with the policies (Yes at 212) the cloud request is sent to the cloud-based service (214). If the request does not comply with the policies (No at 212) the cloud request is blocked, and notification of the denied request may be provided (216).

The cloud security proxy may operate as a software-as-a-service (SaaS) offering. End-users may connect to the service via a variety of methods over the internet or via a private connectivity path.

The cloud security proxy may operate as a hybrid software-as-a-service offering. The client may deploy the inspection proxy component of the cloud security proxy in their environment on their chosen infrastructure. The policy and configuration will then be retrieved over the internet or via private connectivity path from the SaaS platform.

Management of customer tenants is a key design consideration when designing a SaaS platform. To support the automated architecture, a pool model providing a single shared database with a single database schema for all tenants can be utilized.

A pool partitioning model for the database layer may facilitate onboarding, drive automation, and reduce management overheads. However, at the infrastructure level, customers may choose to be provisioned within a single cloud provider account construct. Regardless of approach, each customer tenant may be provisioned with:
An organization entity
An encryption key
An application within the identity provider

Some customers may be hosted in a dedicated account to avoid blast radius concerns and to add additional security layers between other tenants.

The cloud security proxy validates traffic by inspecting the payload of each request to determine if the payload contents adhere to rules/policies specified. Each cloud security proxy may be configured to use its own private certificate authority (CA) key. The CA can be configured by either modes: Managed or User_Managed. The first mode, Managed, the cloud security proxy can generate a certificate and store it securely, the customer will be able to download the public CA key to be configured and used on the client side.

Alternatively, if the customer does not want to use a managed certificate, it is possible to upload the customer's own private CA key into the user interface of the cloud security proxy and it will be stored securely and used by the proxy. This allows a customer to use their own certificate which is bundled into either user's desktops/laptops or servers. This would provide a more seamless integration.

In addition to this configuration, a customer also has the option to host a proxy themselves while using their own certificate. This implementation method called “Hybrid” allows the customer to have data inspected “behind the firewall” in their own network, possibly using rules or profiles received from a network location of a SaaS provider. Inspection may be done with their own certificates. In this mode, the cloud security service 116 will not see inspected traffic nor will the service manage client certificates.

Clients can configure their upstream proxy to direct appropriate traffic to the cloud security proxy. The traffic flow between the client's proxy and the cloud security proxy can be handled in numerous different ways. For example, depending upon the client, the client may be connected to the cloud security proxy by a site-to-site virtual private network (VPN), a cloud provider private connectivity path, a network using a public whitelist, etc.

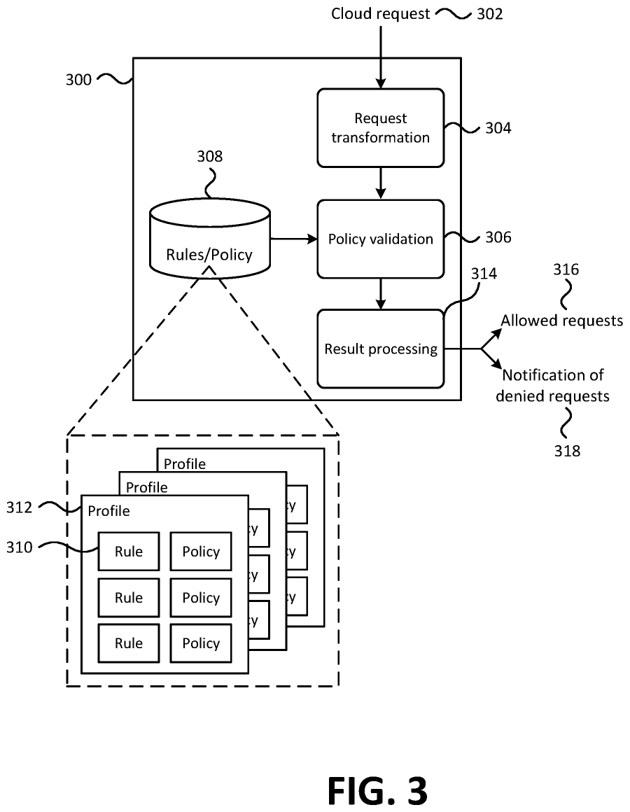

FIG. 3 depicts components of a cloud security proxy. The cloud security proxy 300 may process an API request destined for a cloud provider's service 302 using request processing functionality that may use string manipulation such as regular expressions in order to normalize the request into a standard format. The normalized format may be processed by policy validation functionality 306 that may use a policy-based control language, such as Rego™, to apply one or more policy rules to the normalized request. A rules database 308 may store one or more rules or policies 310 that can be applied to a request. The rules or policies 310 may be stored in association with one or more profiles 312 in order to facilitate specifying a plurality of rules or policies to apply. The result of the policy validation, which may indicate whether the request is approved or denied, can be processed by results processing functionality 314 which may cause allowed requests to by provided 316 to the cloud-based service and block denied requests as well as to provide a notification 318 of the denied requests. A policy may also be individually configured to ‘log’ mode whereby the policy may be evaluated as invalid (denied) but still allowed to proceed to the cloud provider with the outcome of evaluation recorded in logs.

The cloud security proxy validates received cloud requests against one or more rules in order to determine whether or not the request should be allowed. Requests that should be allowed, continue on to the cloud provider, while requests that are not allowed are rejected from being transmitted to the cloud provider and a notification of the rejection may be sent to one or more end users. Each customer may have the ability to create profiles, which are a collection of rules. A rule may be a white-list policy that allows a specific action against a cloud service. Customers can apply one or multiple profiles against an application and each of the rules in that profile will validate against that application. Policies may be set on a whitelist basis, in which if a policy does not allow the explicit API action, it will be denied, and an error returned to the user as described in the diagram above. That is, in a whitelist rule/policy, the rules are used to define allowed actions. Alternatively, the policies may be set on a blacklist basis, in which if a policy does not block the API action it will be allowed. That is, in a blacklist rules/policies the rules are used to define blocked actions.

The rules are applied to requests using a rule/policy engine. The rule/policy engine may use a policy language that applies one or more policies to a request. In order to handle the possibly extremely large number of requests, which may exceed hundreds of millions of requests per month for a single customer, the cloud security proxy handles each request by running through a set of relatively simple filtering condition checks before applying the relatively complex policy check by the policy engine. Cloud requests for different cloud providers may have different request structures.

### Example 1

```
{
  “level”: “info”,
  “timestamp”: “2021-03-02T17:28:41.837+1100”,
  “msg”: “request”,
  “xkid”: “09bbcf45-0bd7-42bd-415b-69420aad7101”,
  “rules”: [{
    “RuleId”: 159,
    “RuleDescription”: “Ensure approved protocols do not
allow ingress rules from 0.0.0.0/0”,
    “RuleProvider”: “AWS”,
    “RuleService”: “EC2”,
    “RuleSteps”: “region/method/path/action
matched,policy_invalid”,
    “Profiles”: [“ACMECorp-High-Risk”, “ACMECorp-
OrganizationWideProfile”, “ACMECorp-Digital-Web”],
    “RuleTags”: {
        “Owner”: “ACMERiskCompliance”,
        “LastUpdatedDate”: “2021-02-03”,
        “NextReviewDate”: “2021-08-03”,
    },
    “Policies”: [{
        “ID”: 69420,
        “Description”: “Ensure no security groups allow
ingress from 0.0.0.0/0 to TCP port 3389 (RDP)”,
        “Enforced”: true,
        “ProcessResult”: true,
        “PolicyTags” : {
          “ComplianceFrameworks”: [
“ISO27001AWS_A.13.1.1”, “NISTAWS-800-53_SC-7”,
“PCIAWS_DSS_1.2.1” ] ,
          “ACMEControlId”: “AWSSG-12.7”
        }
    }]
  }],
  “data”: {
    “ProxyId”: 3,
    “ProxyName”: “ACME-Shared-Network-Proxy-Production”,
    “ProxyTags”: { },
    “OrgId”: 1,
    “OrgName”: “ACME Corp”,
    “AppId”: 1,
    “AppName”: “ACME-Digital-Web”,
    “AppTags”: {
        “BusinessUnit”: “Digital”,
        “ApplicationName”: “Web”,
        “CostCentre”: “69420”,
        “DataClassification”: “Public”,
        “AssetId”: “C-2839190210”
    },
    “Parameters”: {
      “IngressPort”: 3389
    },
    “Profiles”: [{
        “ProfileName”: “ACMECorp-High-Risk”,
        “ProfileTags” : {
            “RiskRating”: “High”,
            “ComplianceFrameworks”: [ “NISTAWS-800-53”,
“ISO27001AWS”, “PCIAWS_DSS” ]
        }
    }, {
        “ProfileName”: “ACMECorp-
OrganizationWideProfile”,
        “ProfileTags”: { }
    }, {
        “ProfileName”: “ACMECorp-Digital-Web”,
        “ProfileTags”: {
            “Owner”: “ACMEDigitalWeb”
        }
    }],
    “Headers”: {
        “Accept-Encoding”: [“identity”],
        “Content-Length”: [“284”],
        “Content-Type”: [“application/x-www-form-
urlencoded; charset=utf-8”],
        “User-Agent”: [“aws-cli/1.18.197 Python/3.8.5
Linux/5.4.72-microsoft-standard-WSL2 botocore/1.19.37”],
        “X-Amz-Date”: [“20210302T062841Z”],
        “X-Kivera-Id”: [“096dcf45-0bd7-42bd-415b-
daab8694201d”]
    },
    “Body”: {
        “Action”: “AuthorizeSecurityGroupIngress”,
        “GroupId”: “sg-1234567890abcdef0”,
        “IpPermissions.1.FromPort”: “3389”,
        “IpPermissions.1.IpProtocol”: “tcp”,
        “IpPermissions.1.IpRanges.1.CidrIp”: “0.0.0.0/0”,
        “IpPermissions.1.IpRanges.1.Description”: “RDP
access from ACME Corporate Office”,
        “IpPermissions.1.ToPort”: “3389”,
        “Version”: “2016-11-15”
    },
    “RawBody”: null,
    “Host”: “ec2.ap-southeast-2.amazonaws.com”,
    “Qs”: { },
    “ReqMap”: { },
    “Method”: “POST”,
    “Path”: “/”,
    “Provider”: “AWS”,
    “Service”: “EC2”,
    “Action”: “AuthorizeSecurityGroupIngress”,
    “Valid”: false,
    “RemoteAddr”: “127.0.0.1:55022”,
    “Referer”: “”
  }
}
```

Each rule is then processed against a normalized request structure. Using the normalized request structure, one or more rules or policies can be applied to each structured request. Each structured request is validated against a set of “Rule/Policy Sets”. Each cloud provider, such as Amazon™ Web Services (AWS), Google™ Cloud Platform (GCP), and Microsoft™ Azure (AZURE) uses a specific a rule/policy engine to normalize the request.

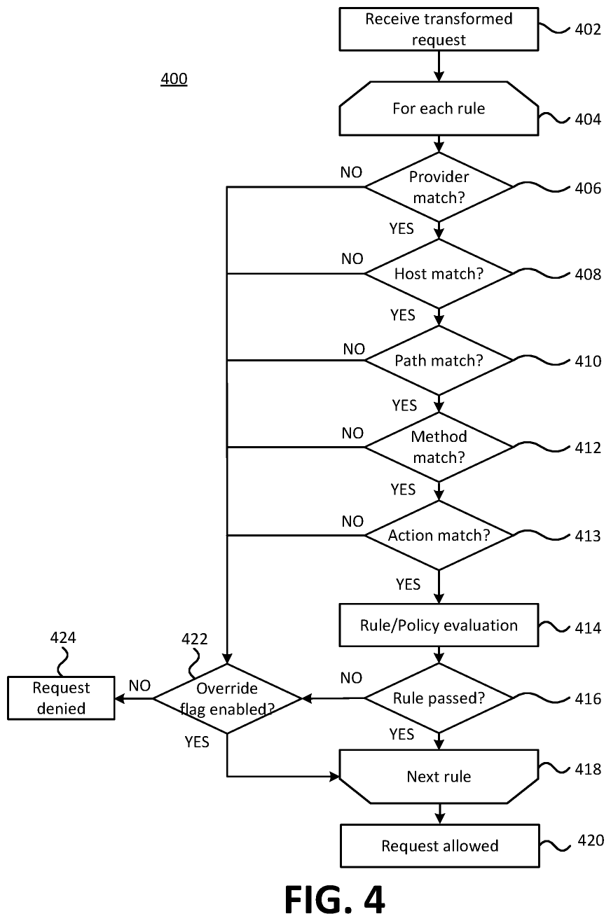

FIG. 4 depicts a method of validating a cloud request. The method receives a normalized request (402) and processes each rule/policy (404) that has been determined to be associated with the request. The rule/policy engine parses each request, for example using regular expressions, and makes a determination to find the particular provider (406) and service of the request. If a provider is supported (yes at 406) the validation progresses to the host (408) then path (410), and method (412). An action may also be evaluated (413) If each check passes host match (yes at 408), path match (yes at, 410), method match (yes at 412) and action match (yes at 413) rule/policy itself is evaluated (414). If the rule passes (yes at 416) the next rule (418) is evaluated. If all of the rules are passed, the request is allowed (420).

If any of the checks fail (No at 406, 408, 410, 412, 413 or 416) the request is denied (424). Using the API method and path for a cloud provider service, the cloud provider action (413) can be determined. For example a GET request to path/API/example can be determined to be a “CreateQueue” action (413) in the cloud provider service. A flag may be associated with the rule/policy, (yes at 422) the request may still be allowed. For example, the flag may identify an invalid policy should still be allowed to be implemented such as for example for testing or logging purposes. If the flag is not set (no at 422) the request is denied (424). This progressive approach to validation allows for rapid processing of requests that do not match the hierarchical categories. Matching each request directly against policy could be resource intensive and may impact performance.

Additional metadata tags may be associated with the processing of the request to provide enrichment to provide enrichment to the request and associated cloud resources. The additional metadata may be utilized for evaluation against subsequent policies, for example adding client policy identifiers to a request to track implementation of policies in the cloud-based service. Alternatively, the metadata tag may be used to track budgeting of features that are implemented and having associated costs. Examples of the additional tags are shown in Example 1, line 16 (RuleTags), line 26 (PolicyTags) and line 53 (ProfileTags). Each Rule/Policy Set may go through an elimination filtering process of the provider, host, path, method and action. If all of the checks pass, the policy engine is used to evaluate the policy against the request. If any of these attributes in the structured request fails, the engine moves to the next rule or policy being applied for evaluation. This technique of “fail fast” reduces the overall response time to the client which should remain at less than 100 ms for the total time spent in the cloud security proxy.

The last step of the process is the policy evaluation, which is where the policy of the rule/policy are used to compare the structured request with the intent of the customer and ultimately resulting in a decision of whether the request should be allowed or denied. A policy language is used to evaluate policies against requests. This is done by taking the structured request as an input applying a policy written in the specific policy language, returning a Boolean value of true/false. An example policy is set forth below:

### Example 2

```
valid {
    input.Action == “AuthorizeSecurityGroupIngress”
  checkGlobVal(input.Body, “*Port”,
    input.Parameters.IngressPort)
  not checkGlobValStartsWith(input.Body, “*CidrIp”,
    “0.0.0.0”)
}
```

The example policy will allow specifying a security group as long as the ingress for the security group is not to or from port 3389 which is defined as a rule parameter and is not from all public IP v4 address CIDR ranges.

Commonly, organizations will be required to adhere to multiple regulatory bodies in the undertaking of their business. Governmental regulators publish a set of regulatory guidance's on how regulated entities should manage their risk as they run applications in public cloud. The published documents, however, are not prescriptive (by intent) and organizations commonly struggle to understand their obligations with the regulator and how they relate to their activities in public cloud. The cloud security proxy may use profiles of rules and policies prepared by regulatory and cloud specialists who navigate regulatory guidance and convert these into sets rules across each of the cloud providers' services. These rule profiles may be managed and maintained for one or more service providers and used by customers to easily ensure that their cloud applications comply with relevant regulations, best practices, etc.

The above has described the cloud security proxy as validating requests from within an organization which are forward to the cloud security proxy by the organization's forwarding proxy. The cloud security proxy may also be used to validate requests extending across multi-cloud service boundaries, for example a request from an application running on AWS infrastructure to an application running on GCP infrastructure. Multi-cloud service boundaries (MCSB) extend the governance of single applications/users accessing a single cloud provider resource by providing a logical boundary around one or more applications and the resources that are being provisioned, modified, or deleted that maybe hosted across multiple cloud providers. For example, an Application-A hosted in AWS may attempt to copy a file to Application-B's Google Cloud Storage (GCS) bucket, which is hosted in GCP. As part of the cloud security proxy authentication the identity of Application A is established so that requests originating from the application can be identified. When building a policy for the GCS bucket it is possible to specify a whitelist of allowed, authenticated applications, in this case—Application A that can request putting an object in the storage bucket. If another Application-C, which may be hosted on premise, tries to put a file into the same bucket, the cloud security proxy would deny the request based on the whitelist which does not contain an entry for Application-C.

The MCSB design is based on the simple premise of 2 entities in a request:
The user or application (identity of the request initiator)
the resource (resource being created, read, updated or deleted)

The policy language, and the normalized structured request, complex business rules and governance can be built into the cloud security proxy greatly reducing the complexity of deployment pipelines (such as Terraform™) and decouple security from deployment tooling. Additionally, users can leverage a common tool to provide governance across cloud platforms reducing the overhead of managing multiple policies. Security teams may have a single pane view of their cloud security posture while providing developers greater flexibility in their choice of deployment tools.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor may be for use in, e.g., a communications device or other device described in the present application.

Numerous additional variations on the methods and apparatus of the various embodiments described above will be apparent to those skilled in the art in view of the above description. Such variations are to be considered within the scope.

What is claimed is:

1. A method for providing security in cloud-based environments, the method comprising:
receiving a cloud service API request intended for a cloud-based service;
processing the received cloud request to a standard format;
determining one or more rules or policies to apply;
applying the determined one or more rules or policies to the processed request;
if all of the rules or policies are passed, transmitting the cloud request to the cloud-based service;
if one or more of the rules or policies are not passed, blocking the cloud request from being transmitted to the cloud-based service.

2. The method of claim 1 wherein if the one or more of the rules or policies are not passed, the request is allowed when an associated flag is set.

3. The method of claim 2 wherein the flag is associated with logging the actions associated with the cloud request.

4. The method of any one of claims 1 to 3 wherein the cloud service API request comprises a create, read, update or delete action.

5. The method of any one of claims 1 to 4, wherein applying the determined one or more rules to the processed request comprises, for each of the rules:
blocking the cloud request if one or more of a provider, host, path, method and action of the processed request does not match a provider, host, path and method of an associated rule.

6. The method of any one of claims 1 to 5, wherein applying the determined one or more policies to the processed request comprises, for each of the policies:
applying a policy if the provider, host, path, method and action of the processed request matches the provider, host, path and method of the rules.

7. The method of any one of claims 1 to 6, wherein the policy comprises a normalized structured request associated with complex business rules or governance parameters to be associated with the cloud-based service.

8. The method of any one of claims 1 to 7, wherein the cloud request is received from a customer network.

9. The method of claim 8, wherein the cloud request is received from a client's forwarding proxy associated with the customer network.

10. The method of any one of claims 1 to 9, further comprising providing a notification to identify the blocked cloud request.

11. The method of any one of claims 1 to 10, wherein the one or more rules or policies are stored in one or more associated profiles.

12. The method of claim 11, wherein each of the profiles is associated with an identifier, wherein the received cloud request is associated with a respective identifier used in determining the rules or policies in profiles to be applied to the cloud request.

13. The method of claim 12, wherein the identifier is associated with a user or application.

14. The method of any one of claims 1 to 13, wherein the received cloud provider API request originated at either a cloud provider or on premise and is destined for a second cloud provider.

15. The method of claim 13, wherein the received cloud request is received from either a cloud provider or on premise via a client's forwarding proxy.

16. The method of any one of claims 1 to 15, further comprising injection metadata into the cloud request to facilitate tracking of an associated implementation.

17. A cloud security proxy comprising a processor and memory storing instructions, which when executed by the processor configure the cloud security proxy to perform the method of any one of claims 1 to 16.

18. A non-transitory computer readable memory having stored thereon instructions which when executed by a processor of a device cause the device to perform the method of any one of claims 1 to 16.
